(19) United States
(12) Patent Application Publication
(10) Pub. No.: US 2017/0183484 A1
(43) Pub. Date: Jun. 29, 2017

(54) IMPROVED HIGH TEMPERATURE MECHANICAL PROPERTIES OF ELASTOMERS WITH SEMI-CRYSTALLINE POLYMERS FOR DOWNHOLE APPLICATIONS

(71) Applicant: Halliburton Energy Services, Inc., Houston, TX (US)

(72) Inventors: Feng Liang, Cypress, TX (US); B. Raghava Reddy, The Woodlands, TX (US)

(21) Appl. No.: 15/313,899

(22) PCT Filed: Jul. 1, 2014
(86) PCT No.: PCT/US2014/045068

§ 371 Date: Nov. 23, 2016

(51) Int. Cl. C08L 9/02; B29C 39/38; B29C 39/00

(52) U.S. Cl. CPC C08L 9/02; B29C 39/003; B29C 39/38; B29K 2995/004; B29K 2105/16

(57) ABSTRACT

Compositions and methods for improving the mechanical properties of elastomers for downhole sealing applications are provided. An embodiment is a composition comprising: a base elastomer; a curative agent; and a semi-crystalline polymer. Another embodiment is a tool comprising: at least one component comprising a vulcanized elastomer, wherein the vulcanized elastomer comprises a base elastomer, a curative agent, and a semi-crystalline polymer. Another embodiment is a method comprising: blending a base elastomer, a curative agent, and a semi-crystalline polymer to form a mixture; placing the mixture in a mold; and vulcanizing the mixture.

### BACKGROUND

The present disclosure provides compositions and methods for improving the mechanical properties of elastomers for downhole applications.

Elastomers are compounds that are commonly used to manufacture components in a variety of downhole tools and other oilfield products including O-rings, gaskets, and packer parts. In particular, elastomers are polymeric materials (i.e., molecules made up of long chains of monomeric units) that exhibit a degree of viscoelasticity. When subjected to mechanical forces, elastomers typically can deform, stretch, extrude, etc. These mechanical properties make many elastomers suited for applications where flexibility is important or it is desirable to create a seal. For example, the portion of a packer that deforms to seal the wellbore when the packer is set in place (known as the element) is typically an elastomer.

Vulcanization is a chemical process for changing the mechanical properties of elastomers. While the specific details of the process can vary, the vulcanization process generally involves combining additives (known as curative agents) with the elastomer and heating the mixture until it reacts. This reaction forms additional crosslinks between the individual chains of the elastomer polymer. As a result of these crosslinks, a vulcanized elastomer is stronger and stiffer than an equivalent elastomer that has not been vulcanized. The vulcanization process can be used to tailor the mechanical properties of an elastomer for a desired application by increasing the strength and stiffness of the elastomer.

However, vulcanized elastomers may still show drastic changes in mechanical properties with an increase in temperature. These changes may include, for example, an increase in modulus and decrease in ultimate elongation before breaking. Such changes may have detrimental effects in product performance. A decreased elongation at high temperatures may have detrimental effect on packer element performance. On the other hand, materials with lower modulus under ambient conditions, but higher modulus at elevated temperatures may suffer from higher compression set, higher explosive decompression, higher extrusion tendencies, or installation damages in sealing applications using O-rings.

### BRIEF DESCRIPTION OF THE DRAWINGS

These drawings illustrate certain aspects of some of the embodiments of the present disclosure, and should not be used to limit or define the claims.

FIG. 1 is a diagram showing a cross-sectional view of a well system illustrating the use of an exemplary packer assembly having components comprising compositions that embody the present disclosure.

FIG. 2 is an enlarged scale cross-sectional view of an exemplary packer assembly having components comprising compositions that embody the present disclosure.

FIG. 3 is a partially cross-sectional view of an alternate embodiment of an exemplary packer assembly having components comprising compositions that embody the present disclosure.

FIG. 4 is a graph illustrating data relating to the retention percentage of the break-point stress at 212° F. and 302° F. (relative to 72° F.) for several embodiments of the present disclosure.

FIG. 5 is a graph illustrating further data relating to the retention percentage of the break-point elongation at 212° F. and 302° F. (relative to 72° F.) for several embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF EMBODIMENTS

The present disclosure provides compositions and methods for improving the mechanical properties of elastomers for downhole applications. In particular, the present application provides elastomer compositions comprising both a base elastomer and a semi-crystalline polymer additive.

There may be several potential advantages to the methods and compositions of the present disclosure, only some of which are alluded to herein. Elastomers used for downhole applications are often subjected to elevated temperatures which reduce mechanical properties such as their strength and stiffness. It has been found that inclusion of certain semi-crystalline polymers as additives in elastomer compositions used for downhole applications may improve the degree of retention of mechanical properties at these elevated temperatures.

In accordance with embodiments of the present disclosure, a composition is provided that comprises a base elastomer, a curative agent, and a semi-crystalline polymer additive. In certain embodiments, the base elastomer provides the majority of the mass of the material. In certain embodiments, the curative agent assists in the vulcanization process. In certain embodiments, the presence of the semi-crystalline additive modifies the mechanical properties of the composition. In certain embodiments, the composition optionally may comprise additional fillers or additives.

Base elastomers that may be suitable for use according to the present disclosure include any elastomer that is capable of being used to manufacture components of tools for use in downhole applications. Examples of suitable base elastomers include, but are not limited to, nitrile butadiene (NBR) which is a copolymer of acrylonitrile and butadiene, carboxylated acrylonitrile butadiene (XNBR), hydrogenated acrylonitrile butadiene (HNBR) which is commonly referred to as highly saturated nitrile (HSN), carboxylated hydrogenated acrylonitrile butadiene (XHNBR), hydrogenated carboxylated acrylonitrile butadiene (HXNBR), ethylene propylene (EPR), ethylene propylene diene (EPDM), tetrafluoroethylene and propylene (FEPM), fluorocarbon (FKM), perfluoroelastomer (FEKM) and the like. It is within the ability of one skilled in the art, with the benefit of this disclosure, to select a suitable base elastomer for use in embodiments of the present disclosure.

Elastomer selection depends on the type of application that the elastomer will be subjected to during the life time of the hydrocarbon production. For example, the elastomer requirements for exploration and drilling phase that utilize mud pumps, cementing equipment and Measurement-While-Drilling devices, may differ from those used in testing and completion phase (utilizing logging equipment, perforating equipment and line packers and hangers) which may differ from those required during production phase (utilizing wellhead equipment, chokes and valves, blow-out preventers, flow management equipment, risers and pipelines and flowlines). Some of the properties the elastomers that may be selected for their suitability for a particular phase in wellbore operations include thermal stability, chemical resistance, extrusion resistance, explosive decompression (i.e., release of permeated or dissolved gases from an elastomer part upon rapid depressurization), compression set (degree of permanent dimension loss upon pressurization and depressurization), hardness, tensile and tear strength, stress relaxation, stiffness, elongation under strain, and ultimate elongation at break, and abrasion resistance. In most cases, these properties should be studied at wellbore conditions. The temperatures, pressures, chemical environments, and other conditions downhole may define the parameters for selection of suitable elastomers. At extreme temperatures and pressure, the range of potentially-suitable elastomers may become very limited and expensive (e.g., perfluoroelastomers).

A variety of curative agents also may be suitable for use according to the present disclosure. Without limiting the present disclosure to any particular theory or mechanism, the curative agents may react with the base elastomer during the vulcanization process and create crosslinks between the polymer chains of the base elastomer to form a three-dimensional crosslinked network structure. These chains add strength to the resulting vulcanized elastomers and prevent melting. Examples of suitable curative agents include, but are not limited to organic peroxides, sulfur compounds, and azo compounds. For purposes of this disclosure, the term “elastomers” generally refers to elastomers that are cured prior to being used. In published literature the term ‘rubber’ is typically used to refer to a cured elastomer.

A variety of semi-crystalline polymers may be suitable for use according to the present disclosure as long as the semi-crystalline polymer has both a crystalline zone and an amorphous zone. The crystallinity of semi-crystalline polymers may range from about 10% to about 80% depending on the conditions and manner under which the polymer melt is cooled, and the presence of nucleation additives. The melting points of semi-crystalline polymers may range from about 60° C. to about 325° C., and the glass transition temperatures of the semi-crystalline polymers may range from about −80° C. to about 100° C. Examples of suitable semi-crystalline polymers include, but are not limited to, polypropylene (PP) (syndiotactic or isotactic forms), polyethylene (PE), polyamides (e.g., nylon 12), maleic anhydride grafted polypropylene (e.g., FUSABOND® P MD353D), and maleic anhydride grafted polyethylene (e.g., FUSABOND® E MX11OD), polyphenylene sulfide, crystalline polystyrene, polyetherether ketone (PEEK), polyether ketone, thermoplastic polyimides, polyesters, and combinations or mixtures thereof.

The interaction between the base elastomer and the semi-crystalline polymer determines the properties of the compositions taught by the present disclosure. The base elastomer is typically an amorphous material. It can be subject to high elongation, and it may expand or contract to withstand an applied stress. However, as noted earlier, the elastomer's material properties can change at higher temperatures. The elastomer's material properties change because it has more thermal energy at these higher temperatures, and this increase in thermal energy allows the material to stretch more easily. This impacts both the modulus and the strength of the material. For example, the elongation at the breaking point is reduced.

In contrast, the semi-crystalline polymers used in the present disclosure have both amorphous and crystalline domains. Without limiting the disclosure to a particular mechanism or theory, the crystalline zones are made of highly packed polymer that does not deform or stretch as easily until the melting point is reached, and act as reinforcing solid additives below the melting point. These crystalline zones are not affected by heat to the same degree as the amorphous zones, so their presence allows a composition containing the semi-crystalline polymer to retain more of its mechanical properties even as the temperature increases. Specifically, the inclusion of the semi-crystalline polymer may allow the composition to retain a higher percentage of its strength, elongation and stiffness at higher temperatures relative to its strength and stiffness at lower temperatures. However, when the application temperature exceeds the melting point of the semi-crystalline polymer, the molten liquid phase now present in the elastomer matrix acts to enhance the elongation and lower the modulus at elevated temperatures, thereby reversing the effects of temperature on mechanical properties of the original elastomer containing no semi-crystalline polymer. Additionally, when the application temperature exceeds the polymer melting point, the molten semi-crystalline polymer may compensate for elongation loss the elastomer suffers at elevated temperatures by increasing the elongation. This becomes possible because a softer liquid phase dispersed in a solid elastomer matrix makes the whole composite behave as a relatively softer elastic material.

The base elastomer can be polar or non-polar. The polarity of the elastomer may be controlled by the use of polar monomers, for example acrylonitrile. In some embodiments, the polarity of the elastomer may be increased by introduction of polar groups such as carboxylate groups either into the polymer backbone or by grafting polar groups onto the elastomer. An example of such an elastomer containing carboxylate groups is carboxylated acrylonitrile butadiene rubber (XNBR) or carboxylated hydrogenated nitrile butadiene rubber (XHNBR). Likewise, the semi-crystalline polymer may be polar or non-polar. It is generally advantageous to use a polar semi-crystalline polymer when the base elastomer is polar. In certain embodiments, the backbone monomer unit of the semi-crystalline polymer is a polar molecule. In other embodiments, the backbone unit of the semi-crystalline polymer may be modified with a polar group to make it more compatible with a polar base elastomer. An example of a semi-crystalline polymer that has been modified with a polar group is maleic anhydride grafted polypropylene. Examples of such materials are commercially available under the trade name of FUSABOND® from DuPont. In an embodiment, magnesium oxide or zinc oxide is used in combination with semi-crystalline polymers.

The compositions according to the present disclosure optionally may include other compounds as well. In certain embodiments, the properties of the elastomers can be modified to meet performance requirements by the addition of suitable additives. For example, carbon black, silica, fibers, and other additives are added as reinforcing fillers to increase modulus, hardness and tensile strength. Other additives such as zinc acrylate and zinc methacrylate are added to elastomers cured with peroxides to modify rate and state of cure and to perform grafting reactions onto the elastomer backbone to improve elastomer mechanical properties. Other additives include processing aids, antioxidants and compatibilizers and the like. Selection of suitable elastomer depends on the application temperature range, chemical environment, fluid pressures and mechanical assemblies in which the elastomers are present.

The compositions of the present disclosure may be manufactured by mixing together the components described above. In certain embodiments, the semi-crystalline polymer is combined with the base elastomer in a range of about 10 to about 20 parts per hundred parts of base elastomer. However, in other embodiments, the semi-crystalline polymer can be present in as low as 5 parts per hundred or as high as 25 parts per hundred. Likewise, in certain embodiments, the curative agent can be combined with the base elastomer in a range of about 2 to about 15 parts per hundred parts of base elastomer. In other embodiments, the curative agent may be present in a range of about 4 to about 8 parts per hundred. The amounts of the curative agents added define the degree of crosslinking of the elastomer components, and as a result affect the hardness, and elastic modulus and degree of elongation. It is generally accepted that higher the crosslinking, higher the hardness and modulus and lower the elongation.

When the component materials have been combined, they can be melt-blended to produce a relatively homogeneous mixture. They are blended at a temperature of about 70° C., although the blending temperature will depend on the melting temperature of the component materials. However, it is important that the blending temperature is kept below the vulcanization temperature to prevent the composition from prematurely curing. The composition is typically in a liquid molten or highly softened state under the blending conditions.

After the components have been blended, the resulting mixture may be poured into a mold of the desired shape. The size and shape is generally determined by the specification and requirements of the final product. For example, the molten composition may be poured into an annular mold if the composition is to be used to make an O-ring or a packing element. However, the composition of the present disclosure may be molded into substantially any shape or size.

The composition is then vulcanized or cured, by heating the composition to a temperature higher than the vulcanization temperature, typically while still in the mold. This heating may cause the base elastomer to react with the curative agents, as discussed above, and form the cross-links that provide the final product with its strength and durability. Typically, the composition is heated to about 175° C. for at least 20-30 minutes. After the vulcanization has been completed, the composition is cooled and the final product is removed from the mold.

As a result of this process, the semi-crystalline polymer is mixed with the vulcanized elastomer. It has been found that for performance improvement at high temperatures, semi-crystalline polymers such as Nylon may be useful in sealing applications, whereas polymers such as polyolefins or maleic anhydride grafted polyolefins may be suitable for packer elements. Materials with higher stress values at all strain values may be useful in sealing applications, whereas the materials with lower stresses and higher elongations at higher temperatures may be useful in packer applications. Modification of non-polar polyolefin polymers with polar maleic anhydride groups significantly increased ultimate elongations. Moreover, using semi-crystalline polymers may be added to expensive elastomers such as perfloroelastomers (for example KALREZ®) which are high cost-high performance elastomers to reduce the cost of the material without significantly compromising the performance.

Additionally, semi-crystalline polymers may be generally less sensitive to chemical attack than elastomers for several reasons. First, the solubility parameters of typical chemicals encountered in downhole operations are significantly different from those for semi-crystalline polymers. Second, the penetration of chemicals into a crystalline matrix is much less that than into an elastomer matrix. For instance, Solubility Parameters for relevant polymers are: Nylon, 13.5; Nitrile rubber, 8.1; Polyethylene, 8.0; Polypropylene, 7.9 and PTFE, 6.2 (units cal^{1/2}cm^{-3/2}). Most acceptable solvents for butadiene-based rubber type of materials fall in the range of 7.8 to 9.2. For example, the solubility parameter for toluene is 8.9. So, toluene is expected to be a non-solvent for nylon and polyolefins. Therefore, it is likely that chemical compatibility of the composites of the present disclosure will be better than for the base elastomer composition.

The compositions of the present disclosure may be used in a variety of downhole applications including, for example, to manufacture a component of mechanical tools used downhole. In general, the compositions may be suitable for any component of a downhole tool that experiences stresses and deforms in response to these stresses. In certain embodiments, the composition may be used to manufacture the packing element of a bridge plug, packer, or similar tool. In other embodiments, the compositions may be used to manufacture O-rings or gaskets. A person of skill in the art with the benefit of this disclosure would be able to select the appropriate composition for a particular tool based on, among other factors, the material characteristics of the composition and the design requirements of the tool and the component of the tool. For example, as discussed in connection with the data below, materials with higher stress values at all strain values may be useful in sealing applications, whereas the materials with lower stresses and higher elongations at higher temperatures may be useful in packer applications.

In one embodiment, the compositions of the present disclosure may be used to manufacture components used in a packer assembly, such as the sealing element. In this embodiment, the packer assembly may be used to create a physical barrier isolating different zones of an open wellbore from one another in the drilling process. The packer assembly may be introduced downhole in an unexpanded form, until positioned within the wellbore where isolation is needed. The packer assembly (and the sealing element) may then be mechanically expanded to contact a portion of the outer surface of the downhole string and a portion of the inner surface of the casing or wellbore wall. The expansion of the packer assembly may create a barrier between the downhole string and the inner casing or exposed wall of the wellbore. These barriers may be able to withstand high temperatures and pressures, allowing for isolation of different zones of the well. In some examples, a retrievable packer assembly may be used wherein the packer assembly is introduced downhole and used for completion of a job, but is then retrieved by retracting the seal element so that the packer assembly can be retrieved from the wellbore.

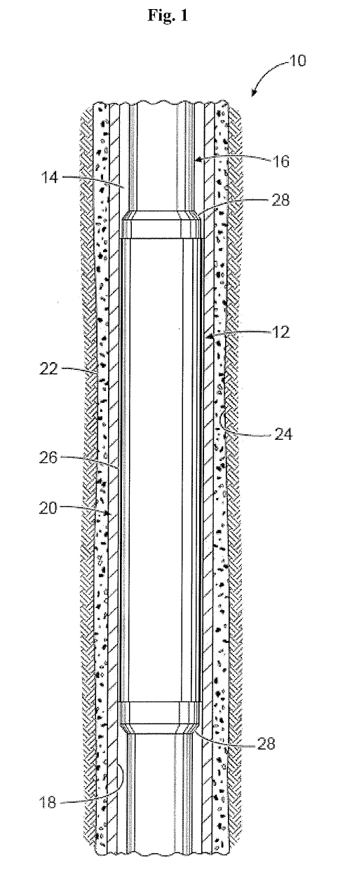

The illustrative embodiment of FIG. 1 shows a well system 10 in which such an exemplary packer system may be used. In the system 10, a packer assembly 12 is used to provide a fluid and pressure barrier in an annulus 14 formed between a tubular 16 and a wellbore interior surface 18. Although the surface 18 is depicted in FIG. 1 as being formed on an interior of a casing, liner or other type of tubular string 20 which is encased in cement 22, the surface 18 could instead be formed on an interior wall of a formation 24 (for example, in an uncased portion of the well), or could be any other surface in the well. The packer assembly 12 includes a seal element 26 which is outwardly extended to sealingly contact the surface 18. In this embodiment, the seal element 26 is disposed on the tubular 16.

In the illustrated example, the seal element 26 may made from a composition that comprises a base elastomer, a curative agent, and a semi-crystalline polymer additive. Further, in this embodiment, the seal element 26 is restricted from displacing longitudinally in the annulus 14 by means of end rings 28 positioned at opposite ends of the seal element 26.

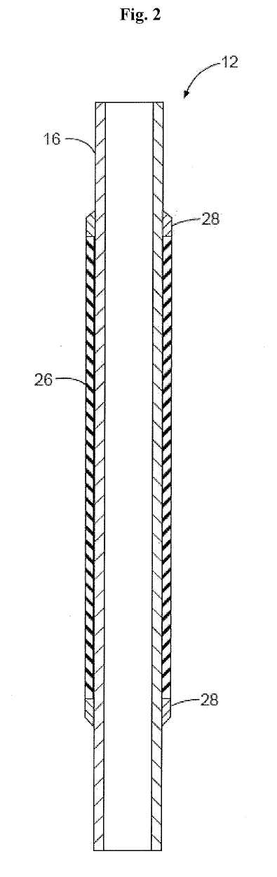

Referring additionally now to FIG. 2, a schematic cross-sectional view of the packer assembly 12 is representatively illustrated apart from the remainder of the well system 10. In this embodiment of the packer assembly 12, the end rings 28 are coupled to a tubular 16. In the well system 10, the tubular 16 could be provided with suitable threaded end connections (not shown), and could be coupled as a part of a downhole string (not shown). The packer assembly 12 could alternatively be used in other well systems, without departing from the principles of the disclosure.

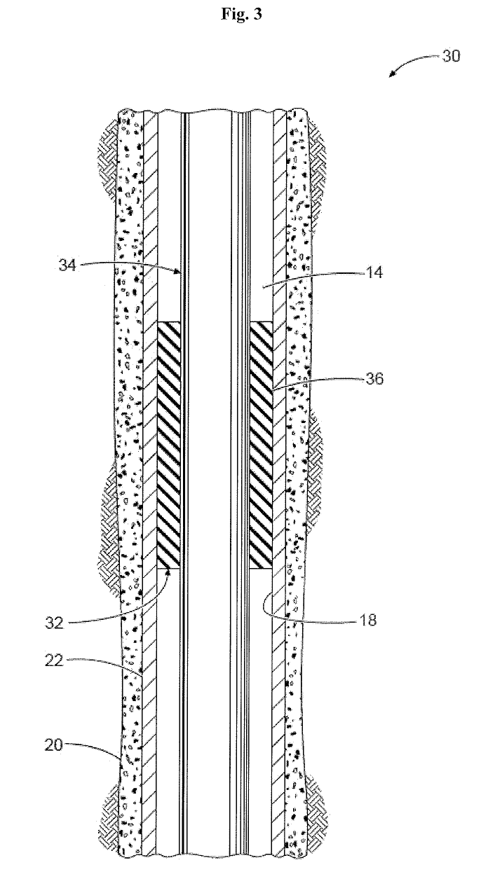

Referring now to FIG. 3, another embodiment of a well system 30 is shown. The packer assembly 32 is shown without longitudinally restrictive elements such as the end rings 28 (shown in FIG. 1). The packer assembly 32 is used to provide a fluid and pressure barrier in an annulus 14 formed between a tubular downhole string 34 and a wellbore interior surface 18. Although the surface 18 is depicted in FIG. 3 as being formed on an interior of a casing, liner or other type of tubular string 20 which is encased in cement 22, the surface 18 could instead be formed on an interior wall of a formation 24 (for example, in an uncased portion of the well), or could be any other surface in the well. The packer assembly 12 includes a seal element 26 which is outwardly extended in order to sealingly contact the surface 18. In this system 32, the seal element 36 is disposed directly on the tubular downhole string 34.

A method of operating the exemplary packer assembly is also provided. The method may include the steps of providing a packer assembly comprising a tubular and at least one seal element disposed on the tubular, wherein the seal element comprises a vulcanized elastomer comprising a base elastomer, a curative agent, and a semi-crystalline polymer additive; positioning the packer assembly in at least a portion of a wellbore; and expanding the seal to contact the interior surface of a casing, liner or other type of tubular string which is encased in cement (the surface could instead be formed on an interior wall of a formation or could be any other surface in the well) and the exterior surface of the tubular. In certain embodiments, the method may further comprise retrieving the packer assembly by allowing the seal element to at least partially retract such that the packer assembly can be retrieved from the wellbore to the surface.

### EXAMPLES

To facilitate a better understanding of the present disclosure, the following examples of certain aspects of some embodiments are given. In no way should the following examples be read to limit or define the scope of the claims.

A series of experiments were performed to test the effects of adding various semi-crystalline polymers to a base elastomer. The base elastomer tested for these experiments was hydrogenated nitrile butadiene rubber (HNBR). All the samples contained 25% N550 carbon black, magnesium oxide (50 micron size) for all compositions except one, and coagents SARET® 5633 and SARET® 5634 from Sartomer Corporation. The samples were cured with peroxide, VUL-CUP® 8100 (a,a′-bis(tert-butylperoxy) diisopropylbenzene, available from Arkema Chemicals.

The vulcanized composite was prepared according to some embodiments described herein using first melt blending (mastication) followed by molding. The composite mixtures were melt blended first using a rubber mixer supplied by Brabender. The mixing chamber of the rubber mixer was pre-heated at 70° C. (158° F.) and the screw rotation rate was set at 30 RPM. The rubber mixer was loaded in the following order: elastomer, semi-crystalline polymer, reinforcing agent, magnesium oxide (when used), coagents and vulcanizing agent, according to the amounts shown in Table 1. The mixture was blended in the rubber mixer for 30 minutes at 30 RPM. The mixture was removed and cut into small pieces for molding into cubic prisms. To vulcanize and mold the mixture into sheets, the blended mixture was loaded into rectangular slot in a metal mold and vulcanized (cured) and compression molded at 177° C. (350.6° F.) for 20 minutes under a load of about 2000 to 3000 pounds. The sheet was stamped with dog-bone shaped molds to obtain specimens for tensile testing. The hardness was measured by Shore A hardness tester, and tensile strengths at different strains were measure on an Instrol tester provided with a heating chamber.

Five semi-crystalline polymers were tested, included polypropylene (PP), polyethylene (PE), nylon 12, maleic anhydride grafted polypropylene (FUSABOND® P MD353D), and maleic anhydride grafted polyethylene (FUSABOND® E MX11OD). The purpose of the latter two materials was to decrease incompatibility between the polar matrix polymer (HNBR) and the non-polar semicrystalline polyolefin polymer by incorporation of polar groups into the non-polar polymers. The melting points of the semi-crystalline were chosen in such a way that they melt around the temperature employed during mixing, and recrystallize subsequent to vulcanization and curing. The melting points of polyethylene (low density), polypropylene, and Nylon 12 are 110-120° C., 157-161° C., and 178° C. (Tg, 37° C.) respectively. The melting points of maleic anhydride grafted PP and PE (linear low density) were 136° C. and 122° C. respectively. The crystalline nature of the polymers was expected to increase the modulus of vulcanized composite at temperatures below their melting points and possibly increase ultimate elongation at temperatures below as well as above melting point of the polymers. All semi-crystalline materials were added at ten parts per hundred parts of base polymer (PHR). The compositions are listed in Table 1 below.

TABLE 1

| | | PHR of | PHR of | | VUL-CUP | Coagents |
|---|---|---|---|---|---|---|
| | Crystalline | Crystalline | Carbon | MgO | 8100 | (Note 1) |
| Composition | Material | Polymer | Black | (PHR) | (PHR) | (PHR) |
| 1 | None (Control) | 0 | 25 | 0 | 10 | 8 |
| 2 | PP | 10 | 25 | 8 | 10 | 8 |
| 3 | FUSABOND ® | 10 | 25 | 8 | 10 | 8 |
| | P MD353D | | | | | |
| 4 | PE | 10 | 25 | 8 | 10 | 8 |
| 5 | FUSABOND ® | 10 | 25 | 8 | 10 | 8 |
| | E MX110D | | | | | |
| 6 | Nylon 12 | 10 | 25 | 8 | 10 | 8 |

Note 1: A mixture of SARET® 5633 and SARET® 5634 each at 4 PHR was used

As shown in Table 2 below, several mechanical properties of the sample compositions were tested at room temperature (72° F.). These properties included the material hardness (Shore A) as well as the tensile strength at various strains. The materials were stretched until they broke, and the stress was measured at intervals: 25% strain, 50% strain, 100% strain, 150% strain, and 200% strain. The tensile stress at the break-point and the elongation at the break-point was also measured.

TABLE 2
Mechanical Properties at 72° F.

| | | Tensile | Tensile | Tensile | Tensile | Tensile | | |
|---|---|---|---|---|---|---|---|---|
| | | Stress | Stress | Stress | Stress | Stress | Tensile | |
| | | @ 25% | @ 50% | @ 100% | @ 150% | @ 200% | Stress | Elongation |
| Crystalline | Hardness | Strain | Strain | Strain | Strain | Strain | @ Break | @ Break |
| Material | (Shore A) | (psi) | (psi) | (psi) | (psi) | (psi) | (psi) | (%) |
| None | 74 | 257 | 474 | 1318 | 2470 | 3589 | 4134 | 228 |
| (Control) | | | | | | | | |
| PP | 79 | 412 | 728 | 1471 | 2335 | 3144 | 3312 | 212 |
| Fusabond P | 79 | 408 | 719 | 1477 | 2371 | 3263 | 3719 | 230 |
| MD353D | | | | | | | | |
| PE | 78 | 356 | 629 | 1444 | 2425 | 3342 | 3360 | 201 |
| Fusabond E | 77 | 357 | 653 | 1556 | 2632 | 3683 | 3882 | 210 |
| MX110D | | | | | | | | |
| Nylon 12 | 81 | 390 | 758 | 1917 | 3259 | — | 3724 | 169 |

The mechanical properties of the compositions were also tested at elevated temperatures. Samples of the compositions were heated to 212° F. and 302° F. At each temperature, a sample was stretched until the sample broke. The tensile stress at the break-point and the elongation at the break-point were measured. The results for 212° F. and 302° F. are shown in Table 3 and Table 4 respectively.

TABLE 3
Mechanical Properties at 212° F.

| | Hardness | Tensile Stress @ | Elongation @ |
|---|---|---|---|
| Crystalline Material | (Shore A) | Break (psi) | Break (%) |
| None (Control) | 74 | 1081 | 86 |
| PP | 79 | 1088 | 91 |
| Fusabond P MD353D | 79 | 1360 | 119 |
| PE | 78 | 933 | 77 |
| Fusabond E MX110D | 77 | 1342 | 97 |
| Nylon 12 | 81 | 1459 | 86 |

TABLE 4
Mechanical Properties at 302° F.

| | Hardness | Tensile Stress @ | Elongation @ |
|---|---|---|---|
| Crystalline Material | (Shore A) | Break (psi) | Break (%) |
| None (Control) | 74 | 760 | 59 |
| PP | 79 | 787 | 67 |
| Fusabond P MD353D | 79 | 916 | 80 |
| PE | 78 | 765 | 59 |
| Fusabond E MX110D | 77 | 989 | 71 |
| Nylon 12 | 81 | 839 | 56 |

As can be seen from the data above, heating the sample compositions lowered the mechanical properties at least to some degree regardless of the presence or type of semi-crystalline material used. For example, as shown in Table 2, the control group's break-point tensile stress at 72° F. is 4134 psi. As shown in Table 3, the control group's break-point tensile stress at 212° F. is 1081 psi. As shown in Table 4, the control group's break-point tensile strength at 302° F. is 760 psi. All of the other samples also exhibited reduced mechanical properties (both tensile strength and elongation) at the break-point as they were heated. However, the mechanical properties were reduced less when a semi-crystalline material was used.

The data in Tables 2-4 were used to calculate the percent retention of mechanical properties at 212° F. and 302° F., and these percentages are shown in Table 5 below. For example, as discussed above, the control group's break-point tensile stress is 4134 psi at 72° F., 1081 psi at 212° F., and 760 psi at 302° F. Thus, the control group retains 26% (i.e., 1081/4134) of the break-point tensile stress at 212° F. and 18% (i.e., 760/4134) of the break-point tensile stress at 302° F. A similar calculation was done for the break-point elongation. Table 5 shows the percent retention for each of the high temperatures tested and each of the mechanical properties measured.

TABLE 5
Percent Retention of Mechanical Properties at 212° F. and 302° F.

| | | % | % | % | % |
|---|---|---|---|---|---|
| | | Retained | Retained | Retained | Retained |
| | | Stress @ | Stress @ | Elongation | Elongation |
| | Crystalline | Break | Break | @ Break | @ Break |
| Composition | Material | (212° F.) | (302° F.) | (212° F.) | (302° F.) |
| 1 | None | 26 | 18 | 38 | 26 |
| | (Control) | | | | |
| 2 | PP | 33 | 24 | 43 | 32 |
| 3 | Fusabond | 37 | 25 | 52 | 35 |
| | P | | | | |
| | MD353D | | | | |
| 4 | PE | 28 | 23 | 38 | 29 |
| 5 | Fusabond | 39 | 26 | 46 | 34 |
| | E | | | | |
| | MX110D | | | | |
| 6 | Nylon 12 | 39 | 23 | 51 | 33 |

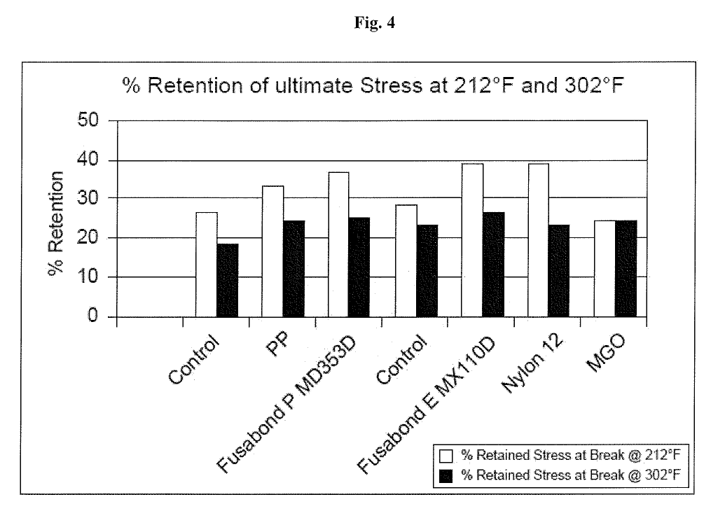

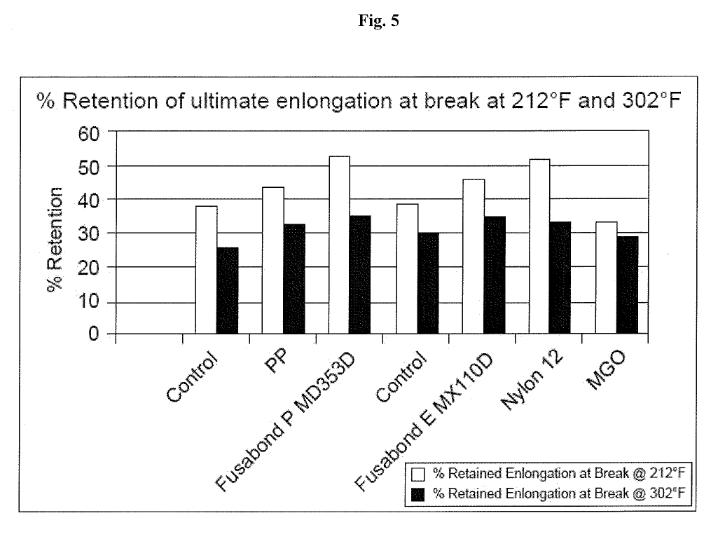

The percent retention of the mechanical properties are also shown in FIGS. 4 and 5. FIG. 4 shows the percent retention of stress at the break-point. FIG. 5 shows the percent retention of elongation at the break point. A comparison of percent retention of mechanical properties at 212° F. and 302° F. for all systems tested indicates that the percent retention of ultimate stress at break (tensile strength), and ultimate elongation at break are increased when semi-crystalline polymers are incorporated into elastomer compositions.

The results also show that semi-crystalline polymers increased the Shore A hardness of the composites by about 4-7 units. Unmodified semi-crystalline polymers, except for nylon 12, lowered moduli and increased elongation at all temperatures. Nylon essentially maintained high modulus at all temperatures, while percent elongations remained similar to the control sample at high temperatures. Modification of non-polar polyolefin polymers with polar maleic anhydride groups significantly increased ultimate elongations. Such materials with higher stress values at all strain values are expected to be useful in sealing applications, whereas the materials with lower stresses and higher elongations at higher temperatures are expected to be useful in packer applications.

An embodiment of the present disclosure is a composition comprising: a base elastomer; a curative agent; and a semi-crystalline polymer. Optionally, the composition further comprises a filler selected from the group consisting of carbon black, silica, fibers, and any combination thereof. Optionally, the base elastomer comprises an elastomer selected from the group consisting of nitrile butadiene, carboxylated acrylonitrile butadiene, hydrogenated acrylonitrile butadiene, carboxylated hydrogenated acrylonitrile butadiene, hydrogenated carboxylated acrylonitrile butadiene, ethylene propylene, ethylene propylene diene, tetrafluoroethylene, propylene, a fluorocarbon, perfluoroelastomer, and any combination thereof. Optionally, the curative agent comprises an compound selected from the group consisting of an organic peroxide, a sulfur compound, an azo compound, and any combination thereof. Optionally, the semi-crystalline polymer comprises a polymer selected from the group consisting of polypropylene, polyethylene, a polyamide, maleic anhydride grafted polypropylene, maleic anhydride grafted polyethylene, polyphenylene sulfide, crystalline polystyrene, polyetherether ketone, polyether ketone, a thermoplastic polyimide, a polyester, and any combination thereof. Optionally, the semi-crystalline polymer comprises at least one polar group. Optionally, the base elastomer and the semi-crystalline polymer are both polar. Optionally, the semi-crystalline polymer is present in an amount of from about 5 to about 25 parts per hundred of the base polymer.

Another embodiment of the present disclosure is a tool comprising: at least one component comprising a vulcanized elastomer, wherein the vulcanized elastomer comprises a base elastomer, a curative agent, and a semi-crystalline polymer. Optionally, the vulcanized elastomer further comprising a filler selected from the group consisting of carbon black, silica, fibers, and any combination thereof. Optionally, the semi-crystalline polymer comprises a polymer selected from the group consisting of polypropylene, polyethylene, a polyamide, maleic anhydride grafted polypropylene, maleic anhydride grafted polyethylene, polyphenylene sulfide, crystalline polystyrene, polyetherether ketone, polyether ketone, a thermoplastic polyimide, a polyester, and any combination thereof. Optionally, the semi-crystalline polymer is present in the vulcanized elastomer in an amount of from about 5 parts per hundred of the base polymer to about 25 parts per hundred of the base polymer.

Another embodiment of the present disclosure is a method comprising: blending a base elastomer, a curative agent, and a semi-crystalline polymer to form a mixture; placing the mixture in a mold; and vulcanizing the mixture. Optionally, the mixture further comprises a filler selected from the group consisting of carbon black, silica, fibers, and any combination thereof. Optionally, the base elastomer comprises an elastomer selected from the group consisting of nitrile butadiene, carboxylated acrylonitrile butadiene, hydrogenated acrylonitrile butadiene, carboxylated hydrogenated acrylonitrile butadiene, hydrogenated carboxylated acrylonitrile butadiene, ethylene propylene, ethylene propylene diene, tetrafluoroethylene, propylene, a fluorocarbon, perfluoroelastomer, and any combination thereof. Optionally, the curative agent comprises a compound selected from the group consisting of an organic peroxide, a sulfur compound, an azo compound, and any combination thereof. Optionally, the semi-crystalline polymer comprises a polymer selected from the group consisting of polypropylene, polyethylene, a polyamide, maleic anhydride grafted polypropylene, maleic anhydride grafted polyethylene, polyphenylene sulfide, crystalline polystyrene, polyetherether ketone, polyether ketone, a thermoplastic polyimide, a polyester, and any combination thereof. Optionally, the semi-crystalline polymer comprises at least one polar group. Optionally, the base elastomer and the semi-crystalline polymer are both polar. Optionally, the semi-crystalline polymer is present in an amount of from about 5 parts per hundred of the base polymer to about 25 parts per hundred of the base polymer.

Another embodiment of the present disclosure is a method comprising: providing a packer assembly comprising a tubular and at least one seal element disposed on the tubular, wherein the seal element comprises a vulcanized elastomer comprising a base elastomer, a curative agent, and a semi-crystalline polymer additive; positioning the packer assembly in at least a portion of a wellbore; and expanding the seal to contact at least a portion of an interior surface of the wellbore or a casing disposed in the well bore and at least a portion of an exterior surface of the tubular. Optionally, the wellbore may comprise an uncased hole. Optionally, the method may further comprise allowing the seal element to at least partially retract and/or retrieving the packer assembly from the wellbore to the surface.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A composition comprising:
a base elastomer;
a curative agent; and
a semi-crystalline polymer.

2. The composition of claim 1 further comprising a filler selected from the group consisting of: carbon black, silica, fibers, and any combination thereof.

3. The composition of claim 1 wherein the base elastomer comprises an elastomer selected from the group consisting of: nitrile butadiene, carboxylated acrylonitrile butadiene, hydrogenated acrylonitrile butadiene, carboxylated hydrogenated acrylonitrile butadiene, hydrogenated carboxylated acrylonitrile butadiene, ethylene propylene, ethylene propylene diene, tetrafluoroethylene, propylene, a fluorocarbon, perfluoroelastomer, and any combination thereof.

4. The composition of claim 1 wherein the curative agent comprises an compound selected from the group consisting of: an organic peroxide, a sulfur compound, an azo compound, and any combination thereof.

5. The composition of claim 1 wherein the semi-crystalline polymer comprises a polymer selected from the group consisting of: polypropylene, polyethylene, a polyamide, maleic anhydride grafted polypropylene, maleic anhydride grafted polyethylene, polyphenylene sulfide, crystalline polystyrene, polyetherether ketone, polyether ketone, a thermoplastic polyimide, a polyester, and any combination thereof.

6. The composition of claim 1 wherein the semi-crystalline polymer comprises at least one polar group.

7. The composition of claim 1 wherein the base elastomer and the semi-crystalline polymer are both polar.

8. The composition of claim 1 wherein the semi-crystalline polymer is present in an amount of from about 5 to about 25 parts per hundred of the base polymer.

9. A tool comprising:
at least one component comprising a vulcanized elastomer, wherein the vulcanized elastomer comprises a base elastomer, a curative agent, and a semi-crystalline polymer.

10. The tool of claim 9 wherein the vulcanized elastomer further comprises a filler selected from the group consisting of: carbon black, silica, fibers, and any combination thereof.

11. The tool of claim 9 wherein the semi-crystalline polymer comprises a polymer selected from the group consisting of: polypropylene, polyethylene, a polyamide, maleic anhydride grafted polypropylene, maleic anhydride grafted polyethylene, polyphenylene sulfide, crystalline polystyrene, polyetherether ketone, polyether ketone, a thermoplastic polyimide, a polyester, and any combination thereof.

12. The tool of claim 9 wherein the semi-crystalline polymer is present in the vulcanized elastomer in an amount of from about 5 parts per hundred of the base polymer to about 25 parts per hundred of the base polymer.

13. A method comprising:
blending a base elastomer, a curative agent, and a semi-crystalline polymer to form a mixture;
placing the mixture in a mold; and
vulcanizing the mixture.

14. The method of claim 13 wherein the mixture further comprises a filler selected from the group consisting of: carbon black, silica, fibers, and any combination thereof.

15. The method of claim 13 wherein the base elastomer comprises an elastomer selected from the group consisting of: nitrile butadiene, carboxylated acrylonitrile butadiene, hydrogenated acrylonitrile butadiene, carboxylated hydrogenated acrylonitrile butadiene, hydrogenated carboxylated acrylonitrile butadiene, ethylene propylene, ethylene propylene diene, tetrafluoroethylene, propylene, a fluorocarbon, perfluoroelastomer, and any combination thereof.

16. The method of claim 13 wherein the curative agent comprises a compound selected from the group consisting of: an organic peroxide, a sulfur compound, an azo compound, and any combination thereof.

17. The method of claim 13 wherein the semi-crystalline polymer comprises a polymer selected from the group consisting of: polypropylene, polyethylene, a polyamide, maleic anhydride grafted polypropylene, maleic anhydride grafted polyethylene, polyphenylene sulfide, crystalline polystyrene, polyetherether ketone, polyether ketone, a thermoplastic polyimide, a polyester, and any combination thereof.

18. The method of claim 13 wherein the semi-crystalline polymer comprises at least one polar group.

19. The method of claim 13 wherein the base elastomer and the semi-crystalline polymer are both polar.

20. The method of claim 13 wherein the semi-crystalline polymer is present in an amount of from about 5 parts per hundred of the base polymer to about 25 parts per hundred of the base polymer.
